(19) United States
(12) Patent Application Publication
(10) Pub. No.: US 2008/0043476 A1
(43) Pub. Date: Feb. 21, 2008

(54) FASTENING DEVICE FOR THE FASTENING OF ATTACHMENT PARTS

(75) Inventor: Thomas Henkel, Breidenstein (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Polycadform e.K., Breidenstein (DE)

(21) Appl. No.: 11/768,837

(22) Filed: Jun. 26, 2007

(30) Foreign Application Priority Data
Jun. 27, 2006 (DE) 10 2006 029 826.8

(51) Int. Cl. F21V 19/00

(52) U.S. Cl. 362/362

(57) ABSTRACT

The invention relates to a fastening device for attachment parts (20), more preferably lamps, with at least two connection facility accommodations (22, 23) arranged on a housing (21) of the attachment part for the accommodation of a first connection facility and at least a second connection facility, wherein the first connection facility is designed as adhesive connection facility (24) for forming a surface adhesion force and the second connection facility is designed as spatially positioning fastening device (27).

### CROSS-REFERENCE TO RELATED APPLICATIONS

The present patent application claims priority from German Patent Application No. 10 2006 029 826.8, filed on Jun. 27, 2006.

### BACKGROUND OF THE INVENTION

The invention relates to a fastening device for the fastening of attachment parts, more preferably lamps, with at least two connection facility accommodations arranged on a housing of the attachment part for accommodating a first connection device and at least a second connection device, wherein the first connection device is designed as adhesive connection device for forming a surface adhesion force and the second connection device is designed as spatially positioning attachment device.

The technical area of the invention more preferably relates to the fastening of attachment parts on technical devices, such as for example lamps, which are employed for the lighting of technical installations. More preferably lamps of this type are employed in switching cabinets, device cabinets or similar cabinets. These attachment parts designed as lamps regularly have a compact design and are fastened to horizontal and to vertical profiles or to cabinet walls. If profiles are used as fastening bases, these are frequently designed as perforated grid profile with defined hole spacing. As a rule, installation of these lamps should be performed preferably fast and easily, and the installation technique must be easily adaptable to the fastening requirements of the respective technical conditions.

In connection with lamps designed as attachment parts a number of fastening techniques are known from the prior art such as for instance screw connections, magnetic holding connections, plug or engagement connections. Frequently, however, the fastening technique of such a lamp is matched to a certain application or comprises only one type of fasteners. Lamps are also known which have connection facilities in which different types of fasteners can be inserted. However, the different fasteners have to be supplementarily added to the lamp so that during the installation the appropriate fastener can be selected. In addition, the simultaneous use of two different fastening techniques is not possible, since only one fastener at a time can be inserted in the connection facility of the lamp.

### SUMMARY OF THE INVENTION

The object of the invention is to suggest a fastening device which has different fasteners that can be easily transferred to a fastening configuration without such fasteners having to be separately carried along and replaced. In addition, an installation aid which allows the alignment of the attachment part on a fastening base is to make possible simplified and rapid installation of the attachment part.

This object is solved through a fastening device with the characteristics of claim 1.

The fastening device according to the invention is formed on a housing having at least two connection facility accommodations to accommodate a first connection facility and at least a second connection facility. According to the invention a first connection facility is designed as adhesive connection facility for forming a surface adhesion force which, on the one hand, serves for fixing the attachment part on a fastening base and on the other hand enables changing of the positioning of the attachment part in a fastening plane. The aforementioned connection facility is thus utilizable as installation aid for example to screw the attachment part to the fastening base without the attachment part having to be manually held tight on the fastening base during screwing. According to the invention, the second connection facility is additionally designed as spatially positioning fastening device. Thus, the attachment part can be permanently positioned in a defined three-dimensional position.

In a particularly preferred embodiment of the attachment device, two connection facility accommodations can be formed on each axial end of the housing, wherein a connection facility each can be utilized as installation aid and a further connection facility each can be connected with a fastening base.

In a further advantageous embodiment the spatially positioning fastening device of the attachment part can have two spatially positioning fasteners each. These two spatially positioning fasteners can serve for the connection of the attachment part to different fastening bases such as for instance a perforated grid profile. In addition, the attachment part can be installed in different spatial positions relative to the fastening base.

The spatially positioning fastening device can also have fasteners which, as fastening straps, are designed with a fastening bore to establish a bolt connection with a fastening base. With fastening straps of this type, a screw, engagement pin or rivet connection can be easily established with a fastening base.

It proves particularly advantageous if the fasteners are designed as fastening straps with a fastening projection for engagement in a fastening base. This makes possible insertion or engagement of the fastening straps in through-apertures of a fastening base and thus a positive fastening of the attachment part on the fastening base.

For adapting the attachment part to a fastening base such as for instance a perforated grid profile the connection facility accommodations for accommodating a fastening strap can have a guide accommodation for longitudinally displaceable arrangement of the fastening strap. This makes possible the axial alignment of inter-spaced fastening straps with a given hole distance for screwing two or engagement in a perforated grid profile. An adhesive connection device, which has a form designed to agree with the guide accommodation, can also be inserted in the connection device accommodations.

It is particularly advantageous if the guide accommodation is provided with a grid facility for the relative positioning of the fastening strap. Through the grid facility a fixed setting of two fastening straps, axially spaced from each other, to a given perforated grid spacing of a fastening base can take place. In the same way, fixed setting of a fastening projection to a given perforated grid distance can take place.

In a particularly advantageous embodiment at least the connection facility accommodation for accommodating the fastening device can be arranged on a swiveling base arranged in a swiveling manner on the housing. Thus, fasteners of the fastening device can be swiveled into different positions. This makes possible more preferably a change of the fasteners through swiveling into a keeping, installation or end position without fasteners having to be replaced or separated from the housing. Thus the fastening device can be easily adapted to different fastening requirements.

It proves particularly advantageous if the housing at its axial end is provided with at least a swiveling base each for the swiveling of the fasteners into a fastening configuration protruding over the outer housing dimensions. In this way the housing, with a fastening strap each formed on the swiveling base, can be arranged between two perforated profiles arranged in parallel to each other, as for example in a switching cabinet with 19-inch device accommodations. The fastening straps can be swiveled such that they engage in a through aperture in the perforated grid profile each and can be positively inserted in the through apertures of the perforated grid profiles through swiveling into an axial position alongside the housing. In this way the attachment part can be installed between two perforated grid profiles without additional tools.

If the swivel base is provided with an engagement device for the relative positioning of the fasteners, fixing of the fastening configuration of the housing, for instance between two perforated grid profiles, can be achieved through engaging the swivel base in the housing. It further proves advantageous if the swivel base engages in three different positions in the housing. In this way the swivel base can be fixed in a keeping position, in an installation position and in an end position. This significantly facilitates the insertion of the housing between two perforated grid profiles.

The adhesive connection facility of the fastening device according to the invention can be designed as a magnet. This makes possible the permanent fastening of the housing on a smooth surface such as for instance a steel plate wall of a switching cabinet. In addition, the adhesive connection facility designed as magnet can be utilized as installation aid for the moveable pre-assembly of the attachment part on a perforated grid profile for final screwing.

In further advantageous embodiments of the fastening device the adhesive connection facility can also be designed as suction connection, such as for instance through a suction pump or as adhesive connection.

### BRIEF DESCRIPTION OF THE DRAWINGS

In the following the invention is explained in more detail with reference to the enclosed drawing.

It shows:

FIG. 1: a lamp housing with two connection facility accommodations;

FIG. 2-3: a connection facility accommodation for the arrangement capable of swiveling on a lamp housing with two fasteners;

FIG. 4-5: a lamp housing in a first fastening configuration;

FIG. 6-7: a lamp housing in a second fastening configuration;

FIG. 8-10: a lamp housing in a third fastening configuration.

### DETAILED DESCRIPTION OF THE INVENTION

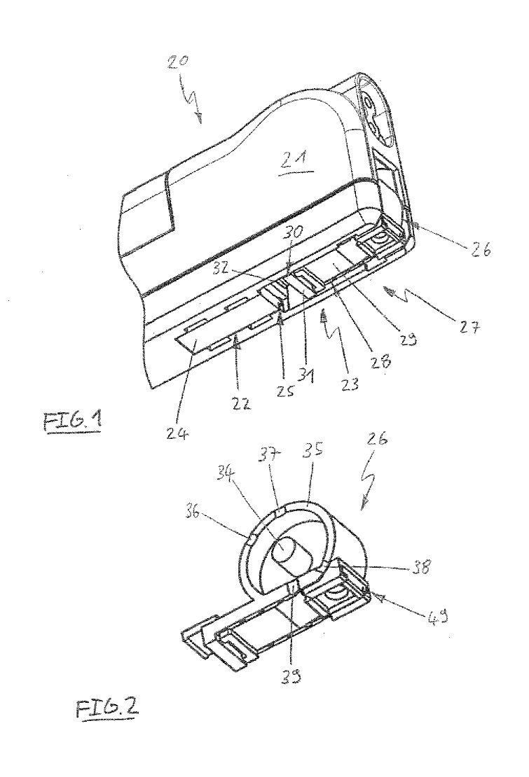

FIG. 1 shows an attachment part designed as lamp 20 with a part section of a housing 21, a first connection facility accommodation 22 and a second connection facility accommoation 23. Here, a connection facility designed as magnet 24 is inserted in the connection facility accommodation 22 and accommodated in a guide accommodation 25 in a longitudinally displaceable manner. The connection facility accommodation 23 is arranged on a swiveling base 26 connected in a swiveling manner with the housing 21 and designed as spatially positioning fastening device 27. The fastening facility 27 has a first fastener 28 which is designed as fastening strap 29 and a second fastener 30 which is designed as fastening strap 31 with a fastening projection 32. In the shown keeping position, the fasteners 28 and 30 of the connection facility accommodation 23 cannot be immediately utilized for installation to a fastening base not shown here. In contrast with this, the magnet 24 which is accommodated in the connection facility accommodation 22 can be used for fastening the lamp 20 to a fastening base.

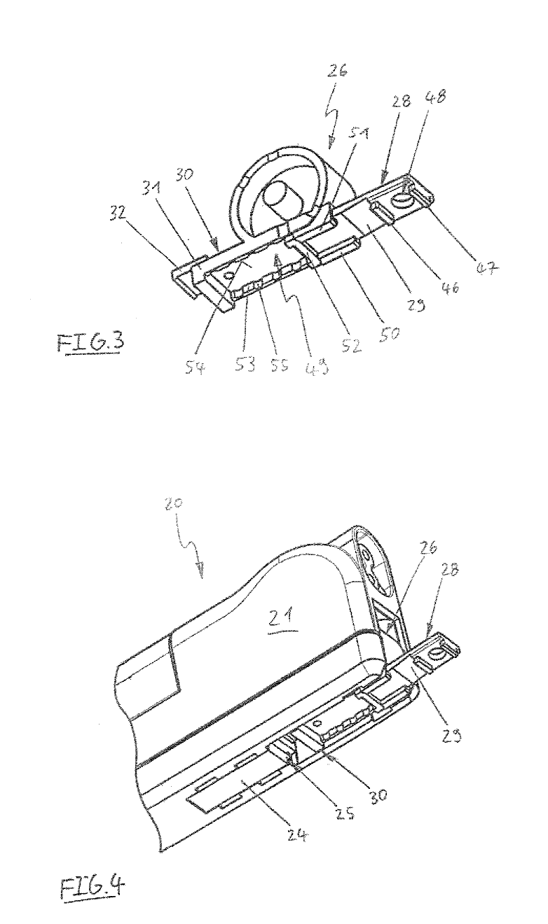

FIG. 2 and 3 show the swivel base 26 on which a swivel shaft 34 is formed which can be inserted in recesses of the housing 21 which is not shown here. On an outer largely ring-shaped circumferential body 35 of the swivel base 26, engagement recesses 36, 37, 38 and 39 are formed on the lateral surfaces of said circumferential body. The engagement recesses 36, 37, 38 and 39 engage in an engagement lug of a housing not shown here and thus make possible fixing of the swivel base 26 relative to a lamp housing in a keeping position, installation position and end position without the use of tools. In addition, the swivel base 26 has the fastener 30 and the fastener 28. The fastener 30 has the fastening strap 31 with the fastening projection 32 for insertion in a through-aperture of a perforated grid profile not shown here. The fastener 28 has the fastening strap 29 with a fastening projection 46, a support web 47 and a through aperture 48. The fastening strap 29 is inserted in a guide accommodation 49 in a longitudinally displaceable manner and secured through guide webs 50, 51 in interaction with a stop 52 to prevent falling out. Lateral surfaces 53, 54 of the guide accommodation 49 are provided with a plurality of engagement recesses 55 in which engagement lugs formed on the fastening strap 29 not shown here, engage. The fastening strap 29 can thus be fixed in a defined position relative to the housing 21.

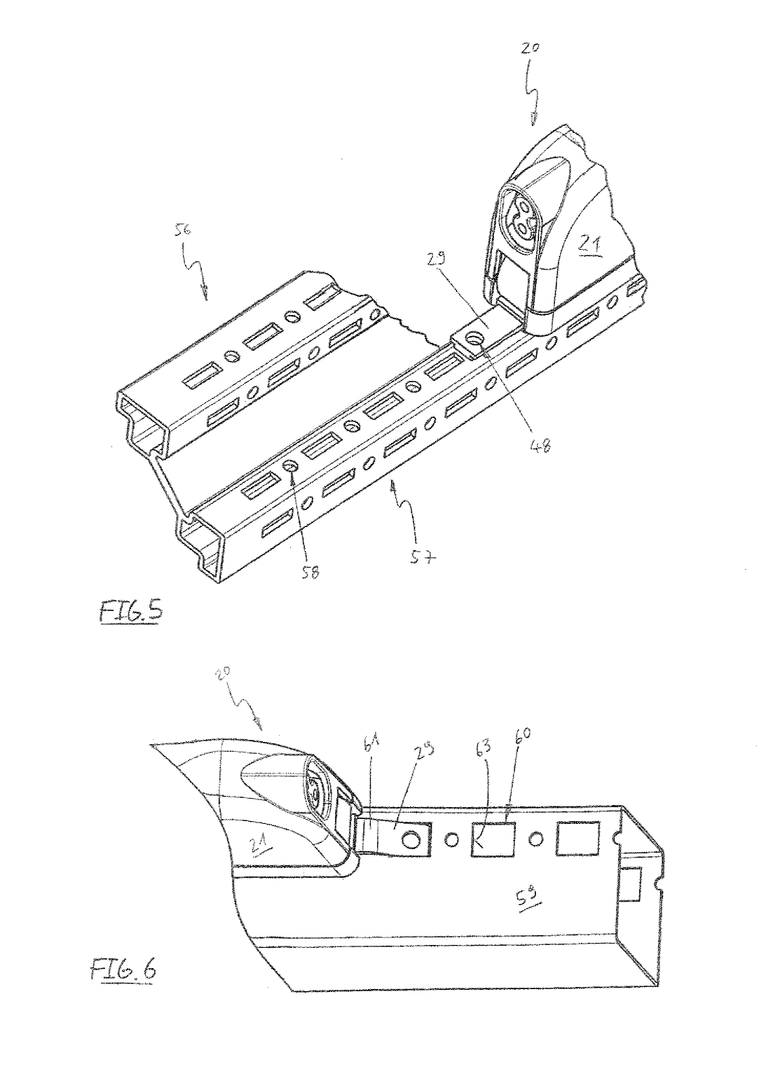

FIG. 4 shows the swivel base 26 represented in FIG. 3 with the fasteners 30 and 28 accommodated by the housing 21 in an outer position relative to the housing 21 and the magnet 24 inserted in the guide accommodation 25.

The viewing of FIG. 4 and FIG. 5 together explains a first possibility of the fastening configuration of the lamp 20 on a perforated grid profile 56. Profile sections 57 with a multiplicity of through apertures 58 are formed on the perforated grid profile 56. The lamp 20 is fixed on the profile section 57 via the magnet 24 such that the through aperture 48 of the fastening strap 29 is in alignment with one of the through apertures 58 of the profile section 57. Thus, the housing 21 can be connected via the fastening strap 29 with a bolt, screw or engagement pin connection not shown in more detail here with the perforated grid profile. The adhesive connection with the profile section 57 formed by the magnet 24 can be utilized during the installation of the housing 21 for the congruent orientation of the through aperture 48 with one of the through apertures 58. In addition, the fastening strap 29 can be adapted to different longitudinal spacings of through apertures 58 in the profile section 57 through the engagement device shown in FIG. 3.

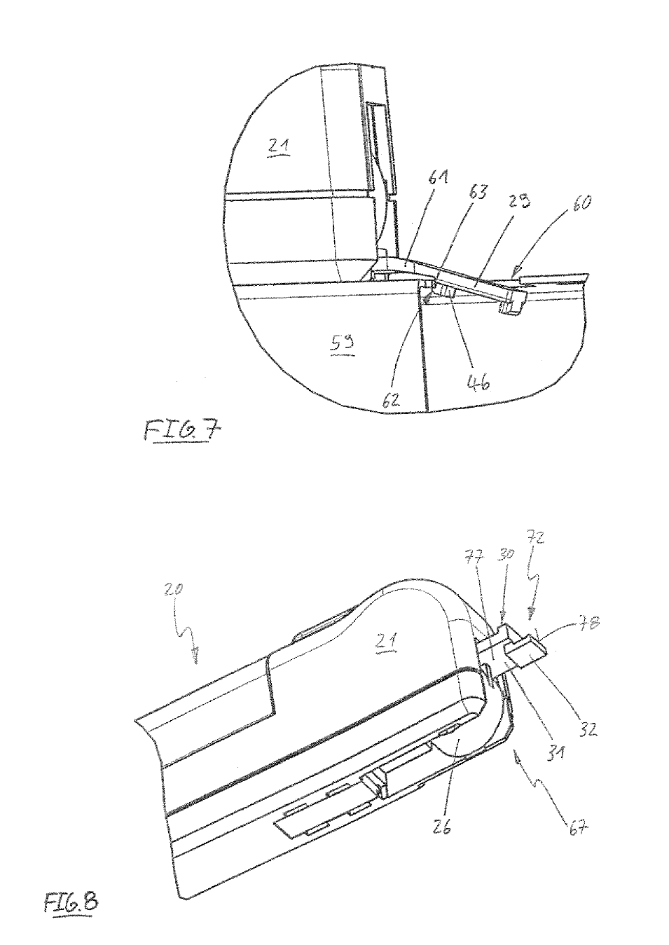

Viewing FIG. 6 and FIG. 7 together shows a further embodiment of a fastening configuration between the housing 21 of the lamp 20 and a perforated grid profile 59. The perforated grid profile 59 is provided with a multiplicity of rectangular through apertures 60 in which the fastening strap 29 can be inserted. In a bending region 61 the fastening strap 29 is angled from its flat extension into an assembly position engaging in the through aperture 60. The fastening projection 46 of the fastening strap 29 engages under an edge 63 of the through aperture 60 with an engagement lug 62 formed on said projection. The fastening strap 29 thus engages in the through aperture 60 by means of the engagement lug 62 and makes possible a positive connection of the lamp 20 with the perforated grid profile 59. Supporting the fastening, an adhesive connection by a magnet which is not shown here can be formed.

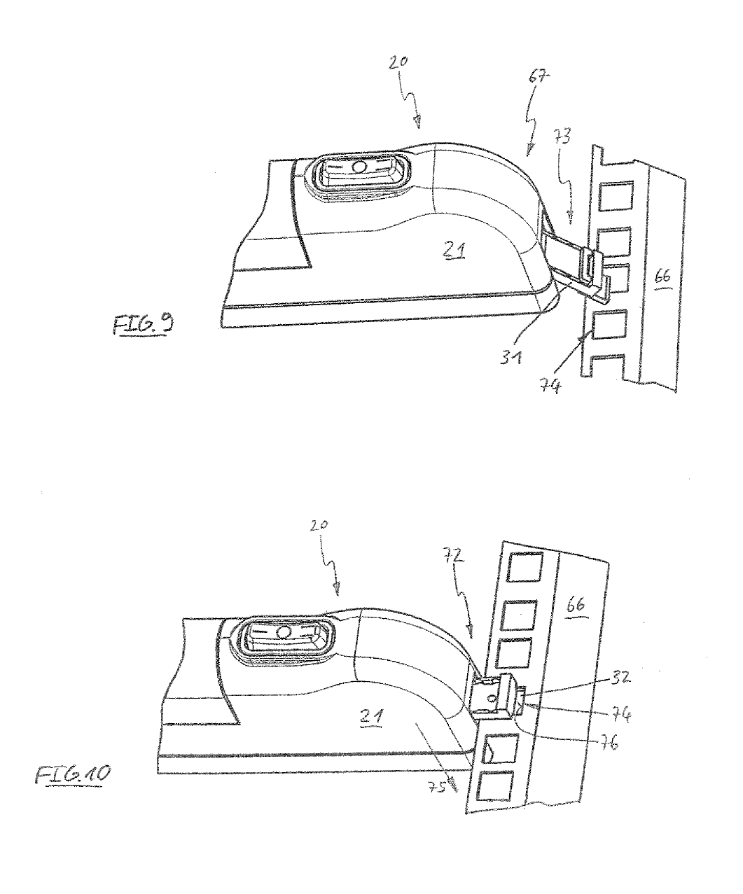

Viewing FIG. 8, 9 and 10 together shows a third exemplary embodiment of a fastening configuration of the lamp 20 with the housing 21 and a perforated grid profile 66. A congruent perforated grid profile running parallel with the perforated grid profile 66 is joined to a housing end not shown here which is located opposite a housing end 67 of the housing 21. The lamp 20 is thus accommodated in the intermediate space between the perforated grid profiles at right angles to the perforated grid profiles.

FIG. 8 shows the swivel base 26 inserted in the housing 21 with the fastening strap 31 of the fastener 30 on which the fastening projection 32 is formed. The fastener 30 in the representation shown in FIG. 8 is in an outer end position 72.

FIG. 9 shows the fastening strap 31 in an installation position 73 before engagement in a rectangular through aperture 74 of the perforated grid profile 66. An end position of the lamp 20 or the fastener 30 is achieved through insertion of the fastening projection 32 in the through aperture 74 and through a movement of the lamp 20 in the direction of the arrow 75 as shown in FIG. 10. The swivel base 26 thus engages in the end position through an engagement facility in the housing 21 not shown here. In addition, the fastening projection 32 upon insertion in the through aperture 74 engages behind an edge 76 of the through aperture 74 and in this way clamps a lower side 77 of the fastening strap 31 to an upper side 78 of the fastening projection 32 which, with simultaneous engagement of the respective swivel bases 26 accommodated on the housing ends 67 of the lamp 20, leads to a positive fastening of the lamp 20 between the perforated grid profiles 66.

What is claimed:

1. A fastening device for the fastening of attachments parts (20), more preferably lamps, with at least two connection facility accommodations (22) arranged on a housing (21) of the attachment part for accommodating a first connection device and at least a second connection device, wherein the first connection device is designed as adhesive connection device for the forming of a surface adhesion force and the second connection device as spatially positioning fastening device (27).

2. The fastening device according to claim 1, characterized in that the spatially positioning fastening device (27) has two spatially positioning fasteners (28, 30) each.

3. The fastening device according to claim 2, characterized in that the fasteners are designed as fastening straps (29, 31) with a fastening bore (48) for establishing a bolt connection with a fastening base.

4. The fastening device according to claim 2, characterized in that the fasteners are designed as fastening straps (29, 31) with a fastening projection (32, 46) for engagement in a fastening base.

5. The fastening device according to claim 1, characterized in that the connection facility accommodations for accommodating a fastening strap have a guide accommodation (49) for the longitudinally displaceable arrangement of the fastening strap (29).

6. The fastening device according to claim 5, characterized in that the guide accommodation (49) is provided with a grid facility for the relative positioning of the fastening strap.

7. The fastening device according to claim 1, characterized in that at least the connection facility accommodation for accommodating the fastening device is arranged on a swivel base (26) arranged in a manner capable of swiveling on the lamp housing.

8. The fastening device according to claim 7, characterized in that the lamp housing at its axial end (67) is at least provided with a swivel base (26) each for swiveling the fasteners into a fastening configuration axially protruding the outer housing dimensions.

9. The fastening device according to claim 8, characterized in that the swivel base is provided with a grid facility for the relative positioning of the fasteners.

10. The fastening device according to claim 1, characterized in that the adhesion connection facility is designed as a magnet (24).
